(19) United States
(12) Patent Application Publication
(10) Pub. No.: US 2005/0166602 A1
(43) Pub. Date: Aug. 4, 2005

(54) Stirling cooler and heat exchanger thereof

(75) Inventors: Jong Jin Park, Inchun-si (KR); Seon Young Kim, Kyungki-do (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/847,298

(22) Filed: May 18, 2004

(30) Foreign Application Priority Data
Jan. 29, 2004 (KR) 2004-5675

(51) Int. Cl. F25B 9/00; F02G 1/04; F01B 29/10

(52) U.S. Cl. 62/6

(57) ABSTRACT

Disclosed are a stirling cooler and a heat exchanger thereof. Since the heat exchanger includes an inner heat exchanger, installed in a heat exchange chamber provided between a case and a cylinder, including a main body having a ring shape contacting the case and the cylinder, and a plurality of through holes formed through the main body for passing a fluid, the heat exchanger has a simple structure and a simplified manufacturing process, allows washing and degassing steps to be easily achieved, and has a maximally increased area for conducting heat in the heat exchange chamber having the limited dimensions, thus improving heat transferring efficiency.

### BACKGROUND OF THE INVENTION

1. Field of the Invention

The present invention relates to a stirling cooler and a heat exchanger thereof, and more particularly to a stirling cooler and a heat exchanger thereof, which comprises an inner heat exchanger including a main body installed between a case and a cylinder and a plurality of through holes formed through the main body in an axial direction.

2. Description of the Related Art

As shown in FIGS. 1 and 2, a conventional stirling cooler comprises a case 4 provided with a cold tip 2 at an opened end thereof, a cylinder 6 fixedly installed in the case 4 and filled with a fluid, a piston 8 installed in the cylinder 6 such that the piston 8 can reciprocate and provided with a hollow 7 formed therein, a displacer 10 installed in the hollow 7 of the piston 8 such that the displacer 10 can reciprocate, a regenerator 12 connected to the displacer 10 in a longitudinal direction, and provided with a cavity 1 positioned between the regenerator 12 and the cold tip 2 and filled with the fluid, and a heat exchanger 20 connected to the cylinder 6 and the regenerator 12.

The piston 8 is connected to a linear motor 14 installed between the case 4 and the cylinder 6, and reciprocates. The displacer 10 is connected to an elastic member 15 installed in the case 4 such that the displacer 10 is opposite to the regenerator 12, thus being elastically supported such that the displacer 10 faces the cold tip 2. A hole 11 is formed in a lower part of the regenerator 12, opposite to the cold tip 2.

The heat exchanger 20 includes an inner heat exchanger 22 installed in a heat exchange chamber 18 prepared between the cylinder 6 and the case 4, and an outer heat exchanger 24 installed on an outer surface of the case 4 so that the case 4 is positioned between the inner heat exchanger 22 and the outer heat exchanger 24.

A first hole 19 communicating with the heat exchanger chamber 18 is formed through cylinder 6, and a second hole 24 communicating with the regenerator 12 is formed through the cylinder 6.

The inner heat exchanger 22 includes a ring-shaped main body 21 obtained by molding a material having a high thermal conductivity and fixed to an inner surface of the case 2, and a pin 23 having a corrugated shape fixed to an inner circumference of the main body 21.

Hereinafter, operation of the above-described conventional stirling cooler will be described in detail.

When the piston 8 moves close to the cold tip 2, the fluid of the cylinder 6 is isothermally compressed, and is discharged to the heat exchange chamber 18 to emit heat. Then, the fluid is introduced into the regenerator 12 to emit sensible heat, and fills the cavity 1 between the regenerator 12 and the cold tip 2 and is isothermally expanded simultaneously. Here, as the fluid fills the cavity 1 between the regenerator 12 and the cold tip 2, the regenerator 12 and the displacer 10 move away from the cold tip 2.

Thereafter, when the piston 8 moves away from the cold tip 2, the displacer 10 and the regenerator 12 are returned to their earlier positions toward the cold tip 2 by the elastic force of the elastic member 19. The fluid filling the cavity 1 between the regenerator 12 and the cold tip 2 subsequently passes through the regenerator 12 and the heat exchange chamber 18 to absorb heat, and re-fills the cylinder 6.

Since the pin 23 must be densely corrugated in order to improve the heat exchange efficiency of the inner heat exchanger 22, the above conventional stirling cooler has an intricate structure, thus having a complicated production process. Further, the density of the corrugations of the pin 23 is limited, thus causing a difficulty in washing and degassing the stirling cooler.

### SUMMARY OF THE INVENTION

Therefore, the present invention has been made in view of the above problems, and it is an object of the present invention to provide a stirling cooler, which has a simple structure and an improved heat transferring efficiency so as to simplify a manufacturing process and allow washing and degassing steps to be easily achieved, and a heat exchanger of the stirling cooler.

In accordance with one aspect of the present invention, the above and other objects can be accomplished by the provision of a stirling cooler comprising: a case provided with a cold tip at an end thereof; a cylinder fixed to the case and filled with a fluid; a piston installed in the cylinder such that the piston can reciprocate; a displacer installed in the piston such that the displacer can reciprocate; a regenerator positioned between the displacer and the cold tip; an inner heat exchanger installed in the case such that the inner heat exchanger is connected to the regenerator and the cylinder; and an outer heat exchanger installed on an outer surface of the case opposite to the inner heat exchanger, wherein the inner heat exchanger includes a main body for transferring heat, and through holes formed through the main body for allowing the fluid to flow into the cylinder and the regenerator.

Preferably, the main body of the inner heat exchanger having a ring shape may be positioned between the cylinder and the case.

Further, preferably, an inner surface of the main body of the inner heat exchanger may contact an outer surface of the cylinder. Moreover, preferably, an outer surface of the main body of the inner heat exchanger may contact an inner surface of the case.

Preferably, the cylinder and the regenerator may be arranged in a line in an axial direction of the cylinder, and the through holes of the inner heat exchanger may be formed in the axial direction of the cylinder.

Further, preferably, the through holes of the inner heat exchanger may be prepared in plural number along a circumferential direction of the main body of the inner heat exchanger. Moreover, preferably, the through holes of the inner heat exchanger may be prepared in plural number along a widthwise direction of the main body of the inner heat exchanger.

In accordance with another aspect of the present invention, there is provided a stirling cooler comprising: a case provided with a cold tip at an end thereof; a cylinder fixed to the case and filled with a fluid; a piston installed in the cylinder such that the piston can reciprocate; a displacer installed in the piston such that the displacer can reciprocate; a regenerator positioned between the displacer and the cold tip; an inner heat exchanger installed in the case such that the inner heat exchanger is connected to the regenerator and the cylinder; and an outer heat exchanger installed on an outer surface of the case opposite to the inner heat exchanger, wherein the inner heat exchanger includes a main body having a ring shape positioned between the cylinder and the case for transferring heat, and through holes formed through the main body along an axial direction for passing the fluid.

In accordance with yet another aspect of the present invention, there is provided a heat exchanger for a stirling cooler, comprising: an inner heat exchanger installed in a heat exchange chamber provided between a case and a cylinder; and an outer heat exchanger installed at the outside of the heat exchange chamber, wherein the inner heat exchanger includes a main body having a ring shape fixed to the heat exchange chamber for transferring heat, and a plurality of through holes formed through the main body along an axial direction.

### BRIEF DESCRIPTION OF THE DRAWINGS

The above and other objects, features and, other advantages of the present invention will be more clearly understood from the following detailed description taken in conjunction with the accompanying drawings, in which:

FIG. 1 is a longitudinal-sectional view of a conventional stirling cooler;

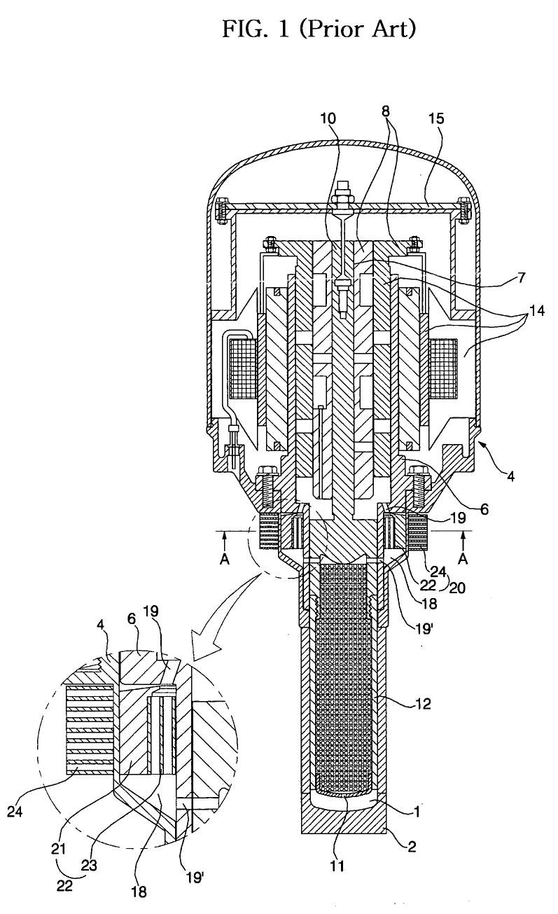

FIG. 2 is a cross-sectional view of the conventional stirling cooler taken along the line A-A of FIG. 1;

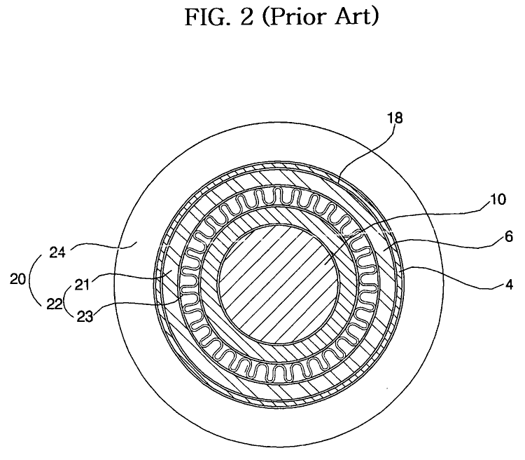

FIG. 3 is a longitudinal-sectional view of a stirling cooler in accordance with the present invention; and

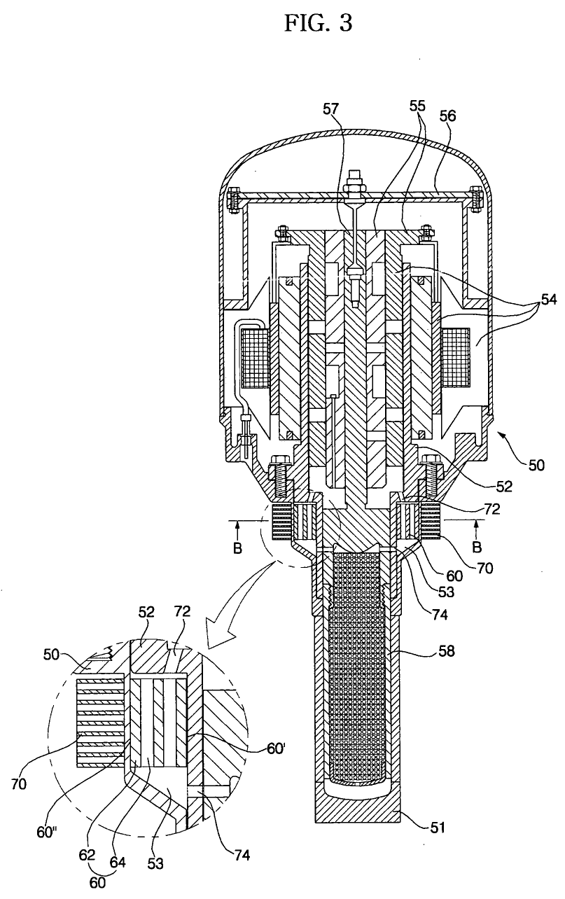

FIG. 4 is a cross-sectional view of the stirling cooler taken along the line B-B of FIG. 3.

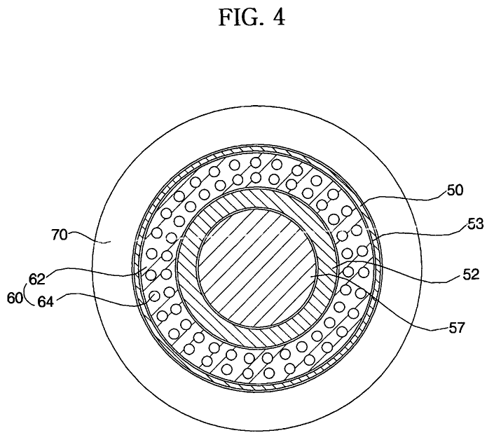

### DESCRIPTION OF THE PREFERRED EMBODIMENTS

Now, preferred embodiments of the present invention will be described in detail with reference to the annexed drawings.

The present invention may comprise several embodiments, but the most preferred embodiment will be described hereinafter. In the following description of the present invention, a detailed description of known functions and configurations incorporated herein will be omitted when it may make the subject matter of the present invention rather unclear.

A stirling cooler in accordance with the present invention comprises a case 50 provided with a cold tip 51 at an opened end thereof, a cylinder 52 fixedly installed in the case 50 and filled with a fluid, a heat exchange chamber 53 positioned between the case 50 and a lower part of the cylinder 52, an inner heat exchanger 60 installed in the heat exchange chamber 53, and an outer heat exchange 70 installed on an outer surface of the case 50 and surrounding the heat exchange chamber 53.

A linear motor 54 is installed between the case 50 and an upper part of the cylinder 52, a piston 55 connected to the linear motor 54 is installed in the cylinder 52 such that the piston 55 can reciprocate, a displacer 57 supported by an elastic member 56 installed on the case 50 is installed in the piston 55 such that the displacer 57 can reciprocate, and a regenerator 58 is installed between the displacer 57 and the cold tip 51.

A first hole 22 communicating with the cylinder 52 is formed through an upper part of the heat exchanger 53, and a second hole 74 communicating with the regenerator 58 is formed through a lower part of the heat exchanger 53. The heat exchange chamber 53 is positioned between the case 50 and the cylinder 52, thereby having a ring-shaped cross-section.

The inner heat exchanger 60 includes a main body 62 obtained by molding a material having a high thermal conductivity for transferring heat, and through holes 64 formed through the main body 62 so that the fluid flows into the cylinder 52 and the regenerator 58.

Since the main body 62 of the inner heat exchanger 60 has a ring shape, which is the same as that of the heat exchange chamber 53, the inner heat exchanger 60 can be installed in the heat exchange chamber 53. The main body 62 of the inner heat exchanger 60 has a designated size such that an inner surface 60′ of the main body 62 contacts an outer surface of the cylinder 52 and an outer surface 60″ of the main body 62 contacts an inner surface of the case 50, thus allowing the fluid introduced into the heat exchange chamber 53 to pass through the inner heat exchanger 60.

Here, the cylinder 52 and the regenerator 58 are arranged in a line in an axial direction of the cylinder 52, and the first hole 72 and the second hole 74 of the heat exchange chamber 53 are separated from each other in the axial direction of the cylinder 52. Thus, the through holes 64 of the inner heat exchanger 60 are aligned in the axial direction of the cylinder 52.

The through holes 64 of the inner heat exchanger 60 are prepared in plural number in a circumferential direction of the main body 62 of the inner heat exchanger 60 so as to increase a contact area between the main body 62 of the inner heat exchanger 60 and the fluid. The through holes 64 of the inner heat exchanger 60 may be spaced from each other in a widthwise direction, i.e., a radial direction, of the main body 62 of the inner heat exchanger 60.

The outer heat exchanger 70 includes a plurality of pins arranged on an outer surface of the case 50 and separated from each other in a circumferential direction of the case 50.

Hereinafter, operation of the above-described conventional stirling cooler will be described in detail.

When the linear motor 54 is operated, the piston 55 moves close to the cold tip 51, and the fluid of the cylinder 52 is isothermally compressed and discharged to the heat exchange chamber 66. Since the main body 62 of the inner heat exchanger 60 is made of a material having a high thermal conductivity, when the fluid flowing into the heat exchange chamber 66 passes through the through holes 64 of the inner heat exchanger 60, the heat of the fluid is absorbed by the main body 62 of the inner heat exchanger 60 and the main body 62 of the inner heat exchanger 60 is cooled by emitting the heat to the outer heat exchanger 70.

After the fluid cooled by the heat exchange chamber 66 is introduced into the regenerator 58 so that the sensible heat of the fluid is absorbed by the regenerator 58, the fluid fills the cavity between the regenerator 58 and the cold tip 51 and is isothermally expanded. When the fluid positioned between the regenerator 58 and the cold tip 51 is isothermally expanded, the regenerator 58 and the displacer 57 move away from the cold tip 52.

Thereafter, when the piston 55 moves away from the cold tip 51 by means of the operation of the linear motor 54, the regenerator 58 and the displacer 57 move close to the cold tip 51 by the elastic force of the elastic member 56. Thereby, the fluid filling the cavity between the regenerator 58 and the cold tip 51 subsequently passes through the regenerator 58 and the heat exchange chamber 53, and re-fills the cylinder 52, thus being isovolumetrically regenerated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A stirling cooler comprising:
a case provided with a cold tip at an end thereof;
a cylinder fixed to the case and filled with a fluid;
a piston installed in the cylinder such that the piston can reciprocate;
a displacer installed in the piston such that the displacer can reciprocate;
a regenerator positioned between the displacer and the cold tip;
an inner heat exchanger installed in the case such that the inner heat exchanger is connected to the regenerator and the cylinder; and
an outer heat exchanger installed on an outer surface of the case opposite to the inner heat exchanger,
wherein the inner heat exchanger includes a main body for transferring heat, and through holes formed through the main body for allowing the fluid to flow into the cylinder and the regenerator.

2. The stirling cooler as set forth in claim 1,
wherein the main body of the inner heat exchanger having a ring shape is positioned between the cylinder and the case.

3. The stirling cooler as set forth in claim 2,
wherein an inner surface of the main body of the inner heat exchanger contacts an outer surface of the cylinder.

4. The stirling cooler as set forth in claim 2,
wherein an outer surface of the main body of the inner heat exchanger contacts an inner surface of the case.

5. The stirling cooler as set forth in claim 1, wherein:
the cylinder and the regenerator are arranged in a line in an axial direction of the cylinder; and
the through holes of the inner heat exchanger are formed in the axial direction of the cylinder.

6. The stirling cooler as set forth in claim 1,
wherein the through holes of the inner heat exchanger are prepared in plural number along a circumferential direction of the main body of the inner heat exchanger.

7. The stirling cooler as set forth in claim 1,
wherein the through holes of the inner heat exchanger are prepared in plural number along a widthwise direction of the main body of the inner heat exchanger.

8. The stirling cooler as set forth in claim 7,
wherein the through holes of the inner heat exchanger are prepared in plural number along a circumferential direction of the main body of the inner heat exchanger.

9. A stirling cooler comprising:
a case provided with a cold tip at an end thereof;
a cylinder fixed to the case and filled with a fluid;
a piston installed in the cylinder such that the piston can reciprocate;
a displacer installed in the piston such that the displacer can reciprocate;
a regenerator positioned between the displacer and the cold tip;
an inner heat exchanger installed in the case such that the inner heat exchanger is connected to the regenerator and the cylinder; and
an outer heat exchanger installed on an outer surface of the case opposite to the inner heat exchanger,
wherein the inner heat exchanger includes a main body having a ring shape positioned between the cylinder and the case for transferring heat, and through holes formed through the main body along an axial direction for passing the fluid.

10. The stirling cooler as set forth in claim 9,
wherein the through holes of the inner heat exchanger are prepared in plural number along a circumferential direction of the main body of the inner heat exchanger.

11. The stirling cooler as set forth in claim 9,
wherein the through holes of the inner heat exchanger are prepared in plural number along a widthwise direction of the main body of the inner heat exchanger.

12. The stirling cooler as set forth in claim 11,
wherein the through holes of the inner heat exchanger are prepared in plural number along a circumferential direction of the main body of the inner heat exchanger.

13. The stirling cooler as set forth in claim 9,
wherein an inner surface of the main body of the inner heat exchanger contacts an outer surface of the cylinder.

14. The stirling cooler as set forth in claim 9,
wherein an outer surface of the main body of the inner heat exchanger contacts an inner surface of the case.

15. The stirling cooler as set forth in claim 14,
wherein an inner surface of the main body of the inner heat exchanger contacts an outer surface of the cylinder.

16. A heat exchanger for a stirling cooler, comprising:
an inner heat exchanger installed in a heat exchange chamber provided between a case and a cylinder; and
an outer heat exchanger installed at the outside of the heat exchange chamber,
wherein the inner heat exchanger includes a main body having a ring shape fixed to the heat exchange chamber for transferring heat, and a plurality of through holes formed through the main body along an axial direction.

17. The heat exchanger as set forth in claim 16,
wherein an inner surface of the main body of the inner heat exchanger contacts an outer surface of the cylinder.

18. The heat exchanger as set forth in claim 16,
wherein an outer surface of the main body of the inner heat exchanger contacts an inner surface of the case.

19. The heat exchanger as set forth in claim 16,
wherein the through holes of the inner heat exchanger are spaced from each other in a circumferential direction of the main body.

20. The heat exchanger as set forth in claim 19,
wherein the through holes of the inner heat exchanger are spaced from each other in a radial direction of the main body.
